(19) United States
(12) Patent Application Publication
(10) Pub. No.: US 2004/0059690 A1
(43) Pub. Date: Mar. 25, 2004

(54) Method for franking and processing deliveries

(76) Inventors: Walter Rosenbaum, Paris (FR); Ingolf Rauh, Reichenau (DE); Christoph Martin, Konstanz (DE)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/668,970

(22) Filed: Sep. 24, 2003

Related U.S. Application Data
(63) Continuation of application No. PCT/DE02/01096, filed on Mar. 26, 2002.

(30) Foreign Application Priority Data
Mar. 29, 2001 (DE) 101 15 585.9

(51) Int. Cl. G06F 17/60

(52) U.S. Cl. 705/401; 705/402; 705/1

(57) ABSTRACT

The present invention comprises a method for franking and processing deliveries, including the following steps: the dispatch client transmits information concerning designated deliveries including details of the recipient to the dispatch service and triggers a process for the payment of the charges; after acceptance of the charge payment process, the dispatch service generates a franking number for each delivery that has been declared, the franking number only being valid for an agreed period of time and thus requiring only a limited number of digits; the franking number is saved together with the recipient details to a searchable franking database; the franking numbers are transmitted to the dispatch client; the latter applies these numbers to the respective deliveries; and the recipient details and the franking numbers of the submitted deliveries are read and searched for in the franking database, whereby once the corresponding entry has been found, the delivery is processed further and the entry is invalidated. This sufficiently secure method has negligible requirements in terms of the application and reading of the franking numbers, in addition to the operation of the franking process and is therefore particularly easy to use.

### CROSS REFERENCE TO RELATED APPLICATION

The present application is a continuation of international application PCT/DE02/01096, filed on 26 Mar., 2002, which designated the United States and further claims priority to German patent number 10115585.9, filed on 29 Mar., 2001, both of which are incorporated herein by reference.

### BACKGROUND OF THE INVENTION

The invention relates to a method for franking and processing deliveries. Electronic methods for franking deliveries have become known in particular for large customers of dispatch services. With such methods, the deliveries are provided with special two-dimensional printed characters which indicate values (two-dimensional barcode) requiring high resolution. This requires high-quality printing and reading technology. Extensive software is required to print and read these characters as increasingly it is necessary to implement security measures to avoid faults and falsifications (including the copying of the characters without permission).

For example, the characters may therefore contain in coded form not only the franking value but also the recipient address or part thereof, a digital signature, a value license number, a serial delivery number, an error correction, The transfer of data and programs must be carried out reliably hereby using encryption methods (WO00/119382, U.S. Pat. No. 5,801,944).

These known methods are very complex and additionally require a precise assignment of the respective envelope with the printed franking information to the contents with the recipient address when window envelopes are used.

### SUMMARY OF THE INVENTION

The invention is therefore based on the object of providing a method for deliveries to be franked by the dispatch customers, which method reduces the necessary expenditure on software and the demands made of the printing and reading technology. According to the invention, the object is achieved by means of the features of claim 1.

Information concerning anticipated deliveries including the recipient details is transferred by the dispatch customer to the dispatch service and triggers a process for the payment of charges, the generation of a franking number for each reported delivery after the charge payment process has been accepted by the dispatch service, the franking number having to be valid only for an agreed time period and therefore also requiring only a limited number of digits, and the storage of the franking number with the recipient details in a searchable franking database, the transfer of the franking numbers to the dispatch customer, the application of these numbers to the respective deliveries by the dispatch customer, the reading of the recipient details and the franking numbers of the submitted deliveries and searching in the franking database, the delivery being further processed after a corresponding entry is found and the entry being made invalid, constitutes a method with sufficient security, which makes only small requirements in terms of the application and reading of the franking numbers and the sequence during the franking, and is thus also particularly low in expenditure.

Here, the following advantages can be mentioned:

1. Customary standard printers can be used.

2. The method can also be used with window envelopes.

3. The method can be integrated without difficulty into the existing OCR/video coding technology as well as the existing automation solutions.

4. The method can also be used with hand-written addresses.

Advantageous refinements of the invention are presented in the subclaims.

It is advantageous, after the dispatch service has determined a valid entry in the franking database, to apply a machine-readable code to the delivery, which code is then the basis for the automatic sorting and distribution processes. This code is advantageously a barcode which characterizes the valid recipient address, and the valid address can also be a forwarding address which is stored in a forwarding database for forwarding facilities.

In a further advantageous embodiment, the dispatch service informs the dispatch customer whether and how the transferred recipient address has to be reformatted before being applied to the delivery so that the OCR reading process runs with as few faults as possible. As a result the reading rate can be increased.

It is also advantageous if the dispatch service informs the dispatch customer of a recipient address which has changed owing to a forwarding facility and is to be applied to the delivery.

So that the franking number is easy to find on the delivery, it can be characterized by one or more additional characters which are easy to identify.

A further possibility of characterizing the franking number is always to apply it at a defined position on the delivery.

In order to characterize this method of franking, it is also advantageous to apply a further character at the location provided for stamps. In order to check whether the dispatch customer has paid the correct level of dispatch charge, it is also advantageous that the dispatch service determines the properties of the deliveries which influence the charges and checks, by reference to a charge table, whether the required amount has been paid. If the charges paid are too low, corresponding top-up payments are demanded from the dispatch customers or recipients.

The franking number can also be used alone, or together with the coded, valid address, for identifying the respective delivery within the framework of tracking transportation and monitoring distribution (track and trace).

### BRIEF DESCRIPTION OF THE SEVERAL VIEWS OF THE DRAWINGS

The novel features believed characteristic of the invention are set out in the claims below. The invention itself, however, as well as other features and advantages thereof, are best understood by reference to the detailed description, which follows, when read in conjunction with the accompanying drawing, wherein:

FIGS. 1-7 show schematic views of the method sequence in various phases.

### DETAIL DESCRIPTION OF THE INVENTION

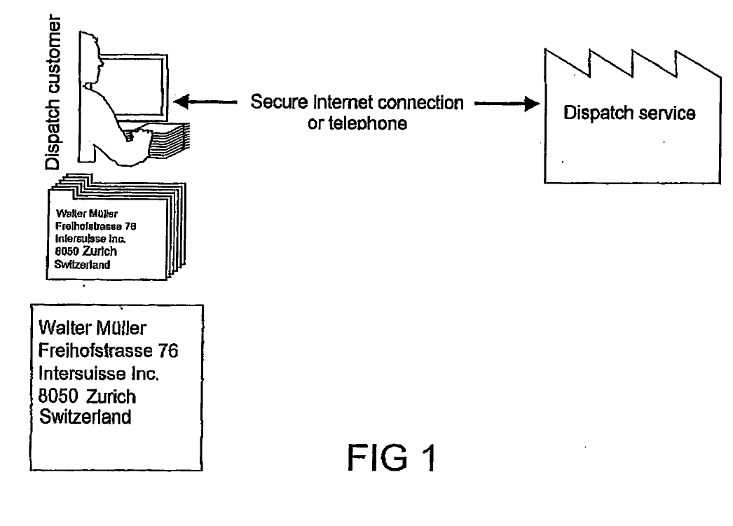

The dispatch customer firstly reports deliveries to the dispatch service and transfers the corresponding recipient details by means of a secure data transmission or else by telephone (FIG. 1).

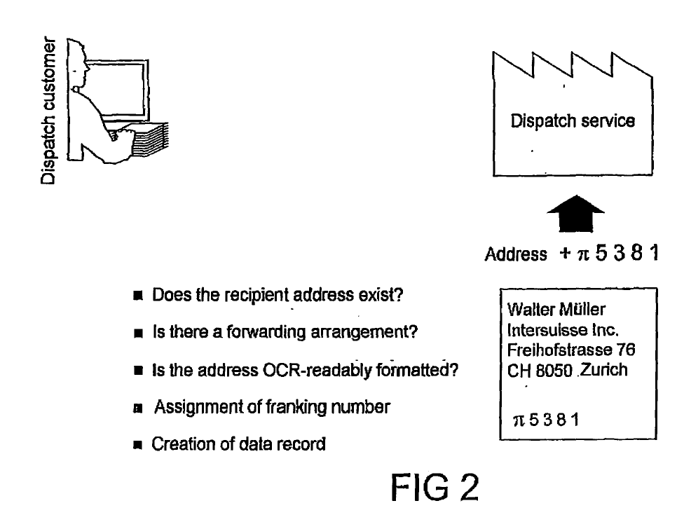

Then, according to FIG. 2, the dispatch service carries out the following steps for each delivery:

1. Checking in the address register to determine whether the address exists. If it does not, a report is sent to the commissioning dispatch customer.

2. Checking in a forwarding database to determine whether the recipient has set up a forwarding arrangement. If they have, the new forwarding address is registered as the address which is now valid.

3. Checking whether the address which has been provided by the dispatch customer has been formatted in accordance with the convention so that an OCR reader can carry out a successful reading process. If this is not the case, the address is reformatted according to the requirements.

4. Generation of a four-digit franking number. On the basis of the available statistical evaluations relating to the occurrence of deliveries and the transit times of the deliveries, a four-digit franking number was defined which ensures that there is no double assignment of a franking number for a specific address during the transit time of the deliveries. For the sake of better identification, a special sign—π—is placed in front of this franking number.

5. Generation of a data record, composed of the valid recipient address and the franking number, and storage in a franking database.

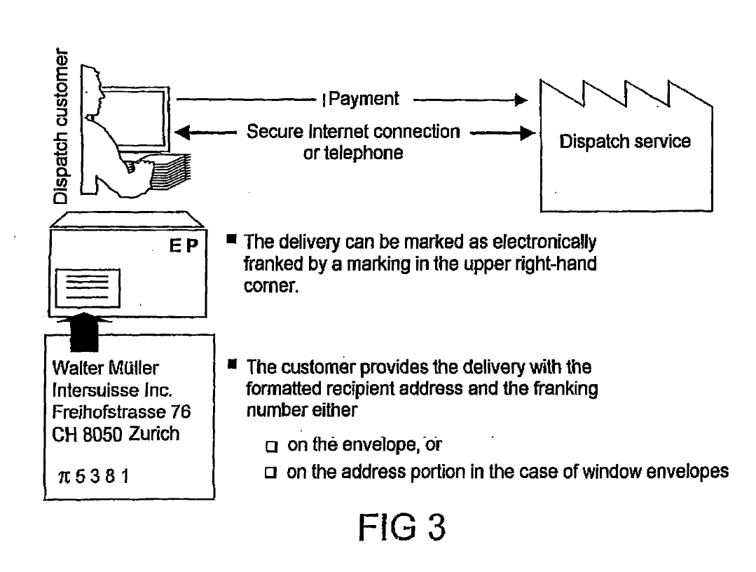

According to FIG. 3, the dispatch service then provides the dispatch customer with the franking number, and possibly the reformatted address or forwarding address, for each delivery over a secure data connection, for example Internet connection, e-mail or telephone connection.

In this example, the recipient address:

Walter Müller was changed into Walter Müller

Freihofstrasse 76 Intersuisse Inc.

Intersuisse Inc. Freihofstrasse 76

8050 Zurich 8050 Zurich.

Switzerland

The charges are then also paid by the dispatch customer. This can be carried out by a different means, which are however known per se, for example by money transfer or else by a debit method with a credit limit.

So that this charge method can be better recognized on the delivery, an additional identifier “EP” (for electronic postage) is applied by the customer to the location provided for stamps. Below the reformatted recipient address, the franking number “π5381” is applied. This can be printed on, but can also be handwritten. If window envelopes are used, the franking number is written into the address area of the insert.

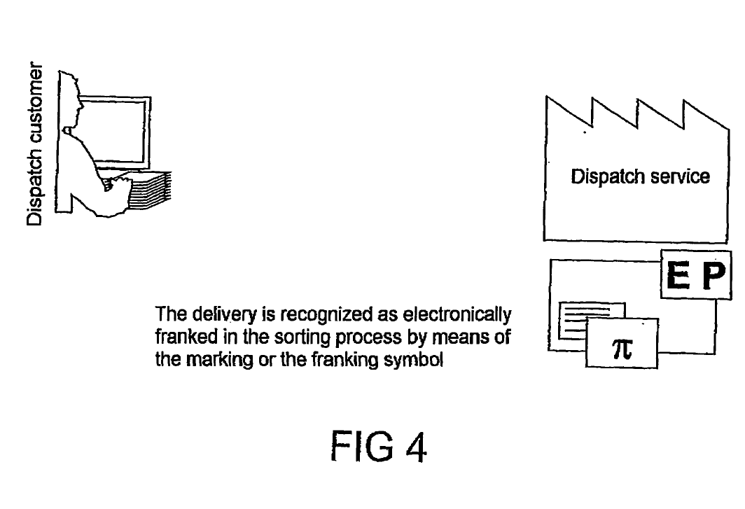

The deliveries are then submitted to the dispatch service and the labels are searched for by means of appropriate reading equipment (OCR). The electronic franking is then recognized by means of the identified characters EP and/or π (FIG. 4).

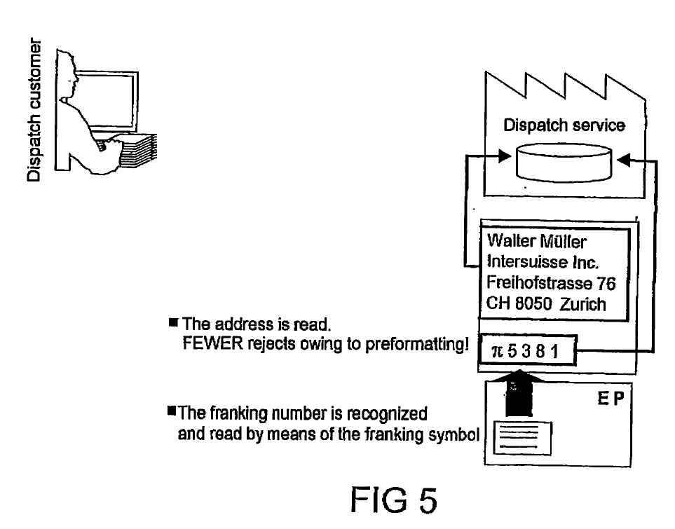

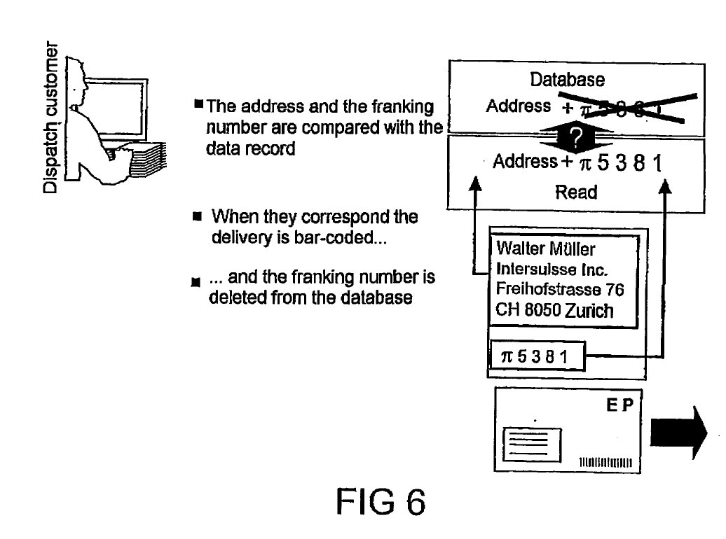

The address is then read with the OCR reader, and if necessary is additionally read at a video coding station. The amount of deliveries rejected is low owing to the correctly formatted addresses. The franking number is also read (FIG. 5), and the franking database is also searched to determine whether a data record with this address and franking number is present. If it is, a machine-readable barcode is applied to the delivery and can be used to distribute the delivery automatically. The franking number is made invalid subsequently or at the latest after the last processing station of the dispatch service has been passed through (FIG. 6).

In the time in which a delivery with “electronic” franking is present in the region of the dispatch service it is possible for further deliveries with the same recipient address or deliveries with the same franking number to be in the distribution process.

The payment of the charges is confirmed only once both are on one delivery, and only when this combination is first found in the franking database.

In order to prevent misuse of this franking number, this franking number is then marked as invalid, i.e. if a second delivery with this recipient address and this franking number is identified it is rejected. This franking number is released again once the delivery has left the dispatch service network or after a fixed time period.

The confirmation is accompanied by the application of the barcode which identifies the recipient address, as a result of which the automatic further processing on the basis of barcode readers becomes possible. This barcode can identify the recipient address directly or else indirectly (by means of an identification number with which the address is determined in a database).

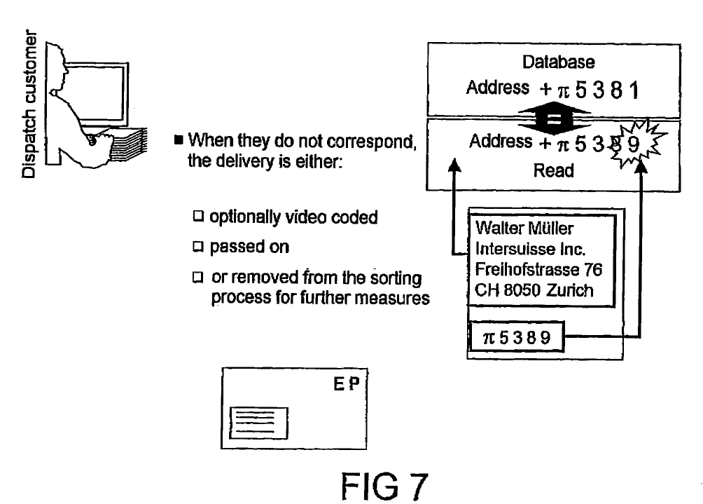

If the address details and the franking number of the read delivery could not be found as a data record in the franking database, it is optionally possible to video code the franking number and repeat the process, or the delivery is removed from the sorting process (FIG. 7)

The reading can at least partially also be carried out by the delivering agent who has access to the franking database via a mobile device and who as it were in the last instance confirms the payment of the charges and makes the franking number invalid.

The following additional refinements provide further advantages:

In order to check whether the charge has been completely paid, the properties of the deliveries (dimensions, weight, type of delivery) which influence the charges are determined at the dispatch service and the charges to be paid are determined therefrom and compared with additional charges paid which are entered in the franking database for each delivery. If the paid charges are too low, subsequent payment demands are made and these are then presented to the dispatcher or possibly the recipient. It is also possible to use the franking number alone or together with the barcode to monitor the transportation process (track and trace).

The invention being thus described, it will be obvious that the same may be varied in many ways. The variations are not to be regarded as a departure from the spirit and scope of the invention, and all such modifications as would be obvious to one skilled in the art are intended to be included within the scope of the following claims.

What is claimed is:

1. A method for franking and processing deliveries, characterized by the following method steps:
a dispatch customer transmits information concerning anticipated deliveries including the respective recipient details to the dispatch service and triggers a process for the payment of the postal charges,
after acceptance of the charge payment process, the dispatch service generates a franking number for each reported delivery and stores it with the provided recipient details in a searchable franking database, the number of digits of the franking number being selected such that each delivery which occurs per recipient is provided with a separate franking number for a specific period of time,
the dispatch service transfers the franking number to the dispatch customer for each reported delivery,
the dispatch customer applies the franking number to the associated delivery in such a way that it can be recognized as such, is uncoded and can be read by a person,
the labels of the deliveries which are submitted to the dispatch service by the dispatch customer are read; after the recipient address has been determined and read and a franking number has been applied, the franking database is searched to determine whether a corresponding entry is present,
after a corresponding valid entry is determined in the franking database, the delivery is further processed and the entry in the franking database is marked as invalid immediately, or at the latest after its registration in the last distribution station;
and if no corresponding entry is found in the franking database, the delivery is rejected.

2. The method as claimed in claim 1, characterized in that, after a corresponding valid entry is determined in the franking database by the dispatch service a machine-readable code—permitting automatic distribution—is applied to the delivery.

3. The method as claimed in claim 2, characterized in that a barcode which characterizes the valid recipient address is applied as a machine-readable code.

4. The method as claimed in claim 3, characterized in that, in order to determine the valid recipient address, the dispatch service checks whether there is a forwarding facility for the recipient and if there is, the forwarding address is coded as a valid address.

5. The method as claimed in claim 1, characterized in that the dispatch service informs the dispatch customer of reformatting, necessary for reliable OCR reading, of the recipient address which is to be applied to the delivery.

6. The method as claimed in claim 1, characterized in that the dispatch service informs the dispatch customer of a recipient address which has changed owing to a forwarding facility of the recipient and is to be applied to the delivery.

7. The method as claimed in claim 1, characterized in that the franking number on the delivery is characterized by one or more additional characters which may easily be identified.

8. The method as claimed in claim 1, characterized in that the franking number is characterized by a defined position on the delivery.

9. The method as claimed in claim 1, characterized in that an additional character for characterizing this franking with the franking number is applied to the location of the delivery which is provided for stamps.

10. The method as claimed in claim 1, characterized in that the level of the charges paid is entered for each delivery in the franking database.

11. The method as claimed in claim 10, characterized in that the dispatch service determines the properties of the deliveries which influence charges and checks whether the charges paid correspond to the charges to be paid, and when the charges paid are too low top-up payments are demanded from the dispatch customers or the recipients.

12. The method as claimed in claim 1, characterized in that the coded, valid recipient address and the franking number are used together for identifying the respective delivery within the framework of tracking transportation and monitoring distribution.
